(19) United States
(12) Patent Application Publication
(10) Pub. No.: US 2024/0076768 A1
(43) Pub. Date: Mar. 7, 2024

(54) FINE GRAINED PURE TITANIUM AND MANUFACTURING METHOD THEREFOR

(71) Applicant: KOREA INSTITUTE OF MATERIALS SCIENCE, Changwon-si, Gyeongsangnam-do (KR)

(72) Inventors: Chan-hee PARK, Changwon-si, Gyeongsangnam-do (KR); Jong-taek YEOM, Gimhae-si, Gyeongsangnam-do (KR); Jae-keun HONG, Changwon-si, Gyeongsangnam-do (KR)

(21) Appl. No.: 18/273,718

(22) PCT Filed: Mar. 7, 2022
(86) PCT No.: PCT/KR2022/003184

§ 371 Date: Jul. 21, 2023

(30) Foreign Application Priority Data
Apr. 22, 2021 (KR) 10-2021-0052275

(51) Int. Cl. C22F 1/18

(52) U.S. Cl. CPC C22F 1/183; C01P 2004/01; C01P 2004/20; C01P 2004/54; C01P 2004/61; C01P 2006/80

(57) ABSTRACT

There is disclosed a fine grained pure titanium having an equiaxed microstructure (a microstructure with an aspect ratio (i.e., the length of a major axis/the length of a minor axis fraction ratio) is less than 3) of 90% or more and an average grain size of 15 μm or less, and a manufacturing method for the same.

### TECHNICAL FIELD

The present disclosure relates pure titanium with refined gains by applying a rolling process.

### BACKGROUND ART

Titanium alloy is an alloy for a structural material with low density, high strength, excellent specific strength and corrosion resistance. Demand for the titanium ally is increasing as an industrial material requiring weight reduction, such as a blade for power generation and a heat exchanger.

Among them, commercially pure titanium (titanium or pure titanium hereinafter means commercially pure titanium) has excellent corrosion resistance and biocompatibility.

However, such pure titanium has a low yield strength due to the characteristics of a hexagonal close packed HCP single phase crystal structure, so its industrial applications have been limited.

In particular, the pure titanium requires a high strength to be applied as an industrial material. This is because the pure titanium as an industrial material is mainly used as a structural material, and structural materials basically require strength.

Conventionally, a grain refinement method has been mainly applied to increase the strength of the pure titanium. Unlike other alloys, in the case of pure titanium, a solid solution strengthening mechanism by the addition of alloying elements or a precipitation strengthening mechanism using the precipitation of precipitates cannot be applied.

Accordingly, in the past, development for high strength of pure titanium has been progressed through plastic working such as drawing, extrusion, rolling or ECAP (Equal Channel Angular Pressing). However, most of the conventional plastic working methods cause a problem in that crystal grains are elongated in a plastic working direction. Titanium having a microstructure including gains elongated in the specific direction as mentioned above has a problem of anisotropy in mechanical properties. Furthermore, when the crystal grains are stretched, breakage like splitting of bamboo tends to occur along the direction in which the crystal grains are elongated.

Accordingly, to make pure titanium with an equiaxed grain microstructure, a method of obtaining a fine equiaxed crystal grain structure through plastic working and post-heat treatment and improving the strength of pure titanium through this has been applied.

The equiaxed crystal grain means a crystal grain having a shape that is not elongated in a specific direction. Accordingly, the equiaxed crystal grain has a different shape from an elongated grain or columnar grain including a grain elongated in a specific direction.

The definition of whether a microstructure corresponds to an equiaxed crystal grain or an elongated grain may be determined by an aspect ratio (a long axis length/a short axis length).

Hereinafter, in the present disclosure when a microstructure is observed with an optical microscope or a scanning electron microscope, if the aspect ratio is less than 3, it is classified as the equiaxed crystal grain and it the aspect ratio is 3 or more, it is classified as the elongated crystal grain or the columnar crystal grain.

Meanwhile, in the case of a general metal including pure titanium, the lower the plastic working temperature, the greater internal storage energy accumulated inside the metal by plastic working. During the post-heat treatment, the accumulated internal energy acts as a driving force for re-crystallization occurring during the post-heat treatment. Accordingly, it is known that the more the internal energy accumulates, the more actively re-crystallization occurs during the post-treatment so that the fine equiaxed crystal grain structure may be well formed.

Conventionally, there may be widely used a method of increasing strain energy accumulated in a material through cold working and performing post-heat treatment.

However, the pure titanium has a problem in that the grain size controllable by the method of cold working and performing post-heat treatment is still large. In particular, there is a problem in that it is difficult to realize pure titanium having a microstructure with about 10 μm of an average size of equiaxed crystal grains even through the cold working and post-heat treatment.

In addition, the cold working process and post-heat treatment method has an inherent problem in that productivity is poor, because the reduction amount per one pass that can be applied to the material during the cold working is limited.

In addition, the cold working and post-heat treatment method has a problem in that it is difficult to increase the total reducing or breakage easily occurs during the cold working, because the total reduction applied to the material during the cold working is limited.

### DESCRIPTION OF DISCLOSURE

Accordingly, one objective of the present disclosure is to provide the above-noted disadvantages of the conventional pure titanium and provide pure titanium with a fine equiaxed grain microstructure through a design of a new rolling process and subsequent heat treatment, and a manufacturing method for the same.

Another objective of the present disclosure is to provide pure titanium with an average grain size of 15 μm or less, and a manufacturing method for the same.

A further objective of the present disclosure is to provide pure titanium with excellent productivity and a fine crystal grain microstructure by increasing the amount of deformation per one pass, and a manufacturing method for the same.

Fine grained pure titanium according to an embodiment of the present disclosure to solve the objectives may have an equiaxed microstructure fraction ratio of 90% or more and an average grain size of 15 μm or less.

An oxygen concentration in the pure titanium may be 0.25 to 0.45 wt. %.

The pure titanium may have a plate shape.

A manufacturing method for fine grained pure titanium according to an embodiment of the present disclosure to solve the objectives may include preparing pure titanium comprising an oxygen concentration range of 0.25 to 0.45 wt. % and other inevitable impurities; processing warm working for the pure titanium at a processing rate of 50% or more based on a cross section area reduction ratio in a temperature range of 400 to 550° C.; and performing sequential heat-treatment in a range of 400 to 570° C. after the warm working process.

An equiaxed microstructure fraction ratio of the pure titanium may be 90% or more.

An average grain size of the pure titanium after the sequential heat-treatment may be 15 μm or less.

The pure titanium may have a plate shape.

The present disclosure may provide the Fine grained pure titanium having an equiaxed microstructure fraction ratio of 90% or more and an average grain size of 15 μm or less, and the manufacturing method for the same. Through this, it is possible to provide pure titanium having excellent mechanical properties, being applicable as a structural material in various industries and having excellent commercial properties, and a manufacturing method for the same.

In addition, according to the manufacturing method for the pure titanium of the present disclosure, pure titanium with excellent productivity and excellent mechanical properties may be produced at a low cost, compared to other manufacturing methods such as ECAP.

In addition, the manufacturing method for the pure titanium of the present disclosure may use the warm rolling, thereby manufacturing pure titanium in various shapes such as a bar material as well as a plate material.

Specific effects are described along with the above-described effects in the section of detailed description.

### BRIEF DESCRIPTION OF DRAWINGS

FIG. 1 shows a microstructure of pure titanium manufactured through a conventional cold working and post-heat treatment (corresponding to Comparative example 1 which will be described later);

FIG. 2 shows a microstructure of pure titanium corresponding to Comparative example 2 of the present disclosure;

FIG. 3 shows a microstructure of pure titanium corresponding to Comparative example 4 of the present disclosure; and

FIG. 4 shows a microstructure of pure titanium corresponding to Example 4 of the present disclosure.

### DESCRIPTION OF SPECIFIC EMBODIMENTS

The above-described aspects, features and advantages are specifically described hereunder with reference to the accompanying drawings such that one having ordinary skill in the art to which the present disclosure pertains can easily implement the technical spirit of the disclosure. In the disclosure, detailed descriptions of known technologies in relation to the disclosure are omitted if they are deemed to make the gist of the disclosure unnecessarily vague.

Below, preferred embodiments according to the disclosure are specifically described with reference to the accompanying drawings. In the drawings, identical reference numerals can denote identical or similar components. As such, the present disclosure should be construed to extend to any alterations, equivalents and substitutes in addition to those which are particularly set out in the accompanying drawings. Terms of respective elements used in the following description are terms defined taking into consideration of the functions obtained in the present disclosure.

It will be understood that although the terms first, second, A, B (a), (b), etc. may be used herein to describe various elements, these elements should not be limited by these terms. These terms are generally only used to distinguish one element from another. It will be understood that when an element is referred to as being “connected with” or “coupled to” another element, the element can be directly connected with the other element or intervening elements may also be present. In contrast, when an element is referred to as being “directly connected with” another element, there are no intervening elements present.

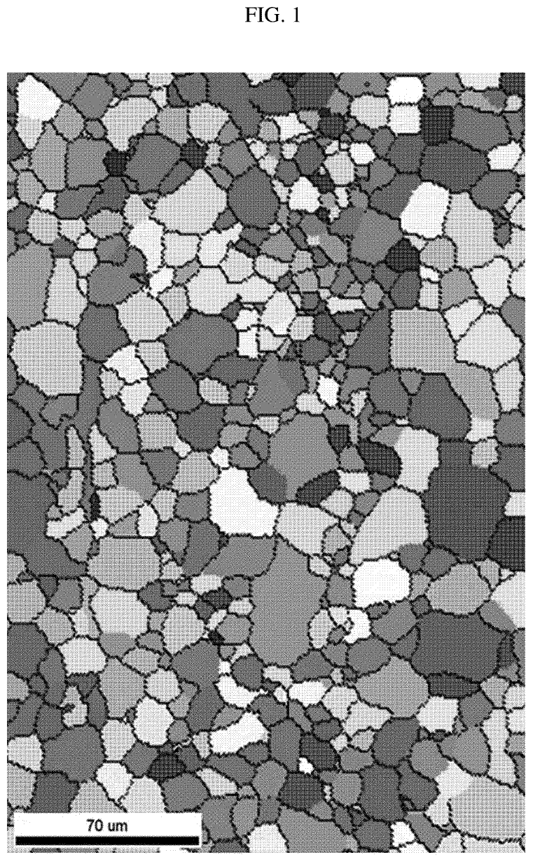

FIG. 1 shows a microstructure of pure titanium manufactured through a conventional cold working and post-heat treatment (corresponding to Comparative example 1 which will be described later). More specifically, the pure titanium of FIG. 1 is the microstructure of pure titanium heat-treated at 500° C. after processed at room temperature with 50% or more of a reduction of area.

As described above, the lower the plastic working temperature of the metal including pure titanium, the higher the energy stored inside the metal by the plastic working. The accumulated internal energy may act as a driving force for recrystallization which means that new crystal grains without defects are created during the post-heat treatment. It is known that If the accumulated internal energy becomes larger, the driving force of recrystallization (particularly, the driving force of nucleation of recrystallization) is increased, resulting in miniaturization of the size of the recrystallized new crystal grains.

Accordingly, a method of accumulating strain energy in a material through cold working and post-heat treatment is commonly used.

As shown in FIG. 1, it is measured that the cold-worked and postly heat-treated pure titanium has equiaxed fine grains as a whole (approximately 97%) with an average grain size of 21.7 μm.

Meanwhile, the inventors of the present disclosure have found that pure titanium having equiaxed fine grains may be manufactured through a manufacturing method different from the conventional heat-treatment after cold working. In particular, it is confirmed that pure titanium manufactured according to the manufacturing method of the present disclosure has more refined crystal grains than the pure titanium obtained by the conventional cold working and sequential heat-treatment.

Specifically, the inventors have found that fine equiaxed structure (equiaxed microstructure fraction ratio of 90% or more, an average grain size of 15 μm or less) are more actively formed in a range where the oxygen concentration of pure titanium is 0.25 wt. % to 0.45 wt. %, unlike the prior art, when strain energy is accumulated in the material through warm working at a specific temperature (400 to 570° C.) and then performing post-heat treatment.

The new manufacturing method according to the present disclosure may prevent breakage by suppressing the generation of elongated crystal grains while increasing the strength of pure titanium.

Hereinafter, experimental examples of the present disclosure will be described in detail.

TABLE 1

| | | Oxygen | Processing | Processing | Heat-treatment | Equiaxed grain | Average |
|---|---|---|---|---|---|---|---|
| | Serial | concentration | temperature | quantity | temperature | fraction ratio | grain size |
| | number | (wt. %) | (° C.) | (%) | (° C.) | (%) | (μm) |
| Example | 1 | 0.25 | 400 | 50 | 400 | 93 | 5.7 |
| | 2 | 0.25 | 550 | 51 | 570 | 98 | 14.3 |
| | 3 | 0.25 | 400 | 87 | 550 | 94 | 10.2 |
| | 4 | 0.37 | 450 | 73 | 500 | 93 | 9.2 |
| | 5 | 0.45 | 400 | 52 | 400 | 91 | 4.2 |
| | 6 | 0.45 | 550 | 51 | 570 | 95 | 13.2 |
| | 7 | 0.45 | 400 | 90 | 550 | 94 | 11.8 |
| Comparative | 1 | 0.14 | Room | 52 | 500 | 97 | 21.7 |
| example | | | temperature | | | | |
| | 2 | 0.14 | 500 | 50 | 500 | 54 | 54.4 |
| | 3 | 0.57 | 350 | It is | | | |
| | | | | difficult | | | |
| | | | | to process | | | |
| | 4 | 0.37 | Room | 73 | 500 | 72 | 26.4 |
| | | | temperature | | | | |
| | 5 | 0.37 | 350 | 75 | 500 | 81 | 22.6 |
| | 6 | 0.37 | 600 | 73 | 500 | 54 | 28.7 |
| | 7 | 0.37 | 450 | 30 | 500 | 68 | 23.9 |
| | 8 | 0.37 | 450 | 73 | 300 | 29 | 31.5 |
| | 9 | 0.37 | 450 | 73 | 600 | 98 | 35.4 |

Next, experimental examples of the present disclosure will be described in detail.

Table 1 above represents the results of Example 1 to 7, which satisfy all the conditions of the manufacturing method according to the present disclosure, and Comparative examples 1 to 9, which do not satisfy some conditions.

In Table 1, Examples 1 to 7 experimentally demonstrate the feasibility of manufacturing a fine crystal grained pure titanium processed material with an equiaxed microstructure fraction ratio of 90% or more and an average grain size of 15 μm or less, when a warm working in a temperature range of 400 to 550° C. with a cross-sectional area reduction ratio of 50% or more and a post heat treatment in a temperature range of 400 to 570° C. are performed for fine-grained pure titanium with an oxygen concentration range of 0.25 to 0.45 wt. % and other inevitable impurities.

Furthermore, the fine-grained pure titanium of the present disclosure may be manufactured through a rolling process as well as the conventional plastic working such as drawing, extrusion or ECAP, so that it can have a microstructure with an average grain size of 15 μm or less even in a plate shape. In particular, if the processed material has a plate shape, it is possible to form a structure only with the processed material so that there may be no restrictions on its use as a structural material.

Hereinafter, by directly comparing above Examples and Comparative examples, the effect of each process condition on the final pure titanium in the manufacturing method for the fine-grain pure titanium according to the present disclosure will be described.

Effect of Oxygen Concentration:

First, Comparative examples 1 to 3 of Table 1 experimentally prove the effect of oxygen concentration in pure titanium in the manufacturing method for the pure titanium.

Comparative examples 1 to 3 of Table 1 represents experimental examples in which the oxygen concentration in pure titanium does not satisfy 0.25 to 0.45 wt. %.

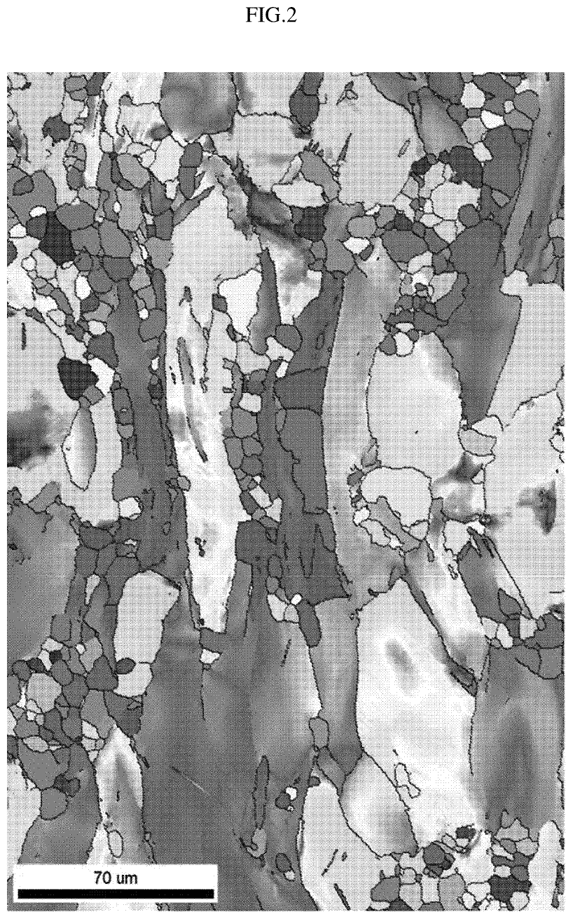

Comparative examples 1 and 2 are the experimental examples in which the oxygen concentration is 0.25 wt. % or less, specifically, 0.14 wt. %. At this time, Comparative example 1 is an experimental example in which the conventional manufacturing method, that is, the cold working process and post heat-treatment is performed. The microstructure of pure titanium manufactured by Comparative example 1 is shown in FIG. 1. In contrast, Comparative example 2 is an experimental example in which the manufacturing method of the present disclosure, that is, the warm working process and post heat-treatment is performed. The microstructure of the pure titanium manufactured by Comparative example is shown in FIG. 2. As shown in FIGS. 1 and 2, it may be clear that the pure titanium of Comparative example has a lower equiaxed structure ratio and a coarser average grain than the pure titanium of Comparative example 1. The results of Comparative example 2 show that when the oxygen concentration in pure titanium is lower than 0.25 wt. %, the pure titanium manufacturing method of the present disclosure using the warm working process forms a non-uniform and coarser microstructure than the conventional manufacturing method for the pure titanium using the cold working process. Furthermore, the experimental results of Comparative Examples 1 and 2 experimentally prove that the oxygen concentration in the pure titanium manufacturing method of the present disclosure should exceed at least 0.14 wt. %.

It is seen that the average grain size is about 21.7 μm, which is still less than a ultra-fine grain size, although the experimental results of Comparative example 1 prove that the conventional manufacturing method for pure titanium is effective in forming the microstructure with equiaxed grains.

Meanwhile, it is impossible to process the pure titanium of Comparative example 3 due to breakage even during the warm working process, in case the oxygen concentration in pure titanium is 0.57 wt. %. The results of Comparative example 3 experimentally prove that when the oxygen concentration in pure titanium exceeds 0.45 wt. %, it is difficult to apply the warm working as well as the cold working.

Accordingly, the results of Comparative examples 1 to 3 experimentally prove that the oxygen concentration in the manufacturing method for pure titanium alloy is effective in the condition of 0.25 to 0.45 wt. %.

Effect of Processing Temperature:

In Table 1, Example 4 and Comparative examples 4 to 6 experimentally prove the effect of the warm working processing temperature in the manufacturing method for pure titanium of the present disclosure.

First of all, Example 4 and Comparative example 4 are corresponding to pure titanium warm working processed (450° C. of the processing temperature) based on the manufacturing method of the present disclosure and pure titanium cold-working processed based on the conventional manufacturing method, respectively.

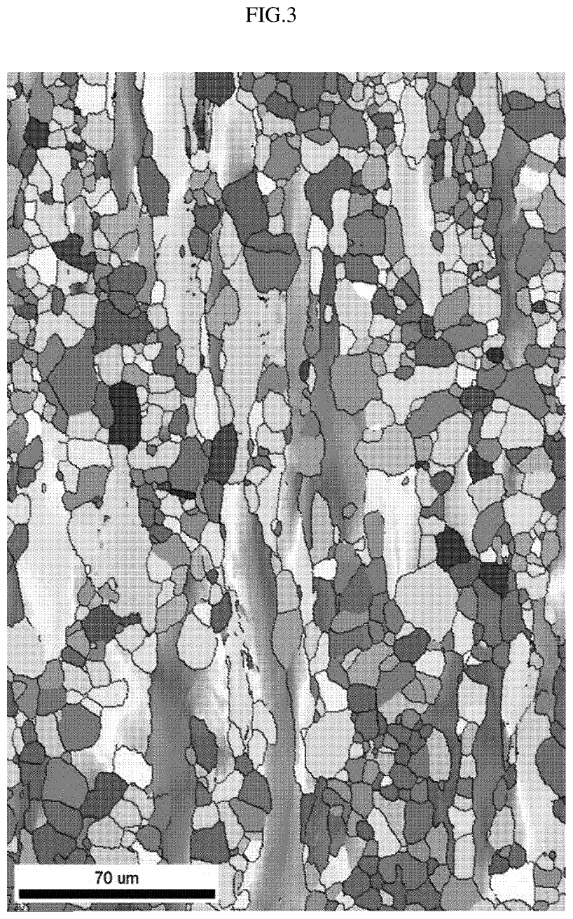

FIG. 3 shows a microstructure of pure titanium corresponding to Comparative example 4 (Cold working) of the present disclosure.

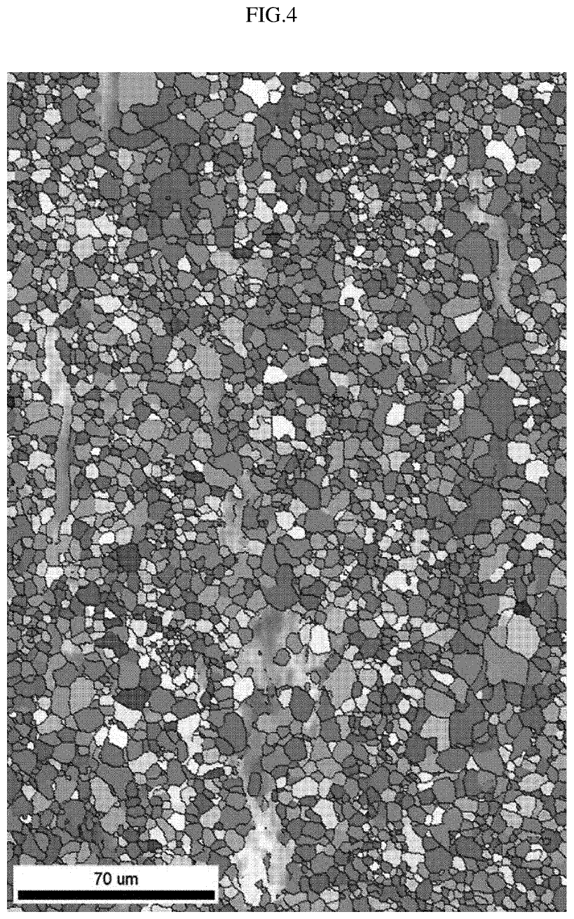

FIG. 4 shows a microstructure of pure titanium corresponding to Example 4 (Warm working) of the present disclosure.

Example 4 and Comparative Example 4 to 6 show pure titanium manufactured under all the same conditions except the process temperature. Specifically, Example 4 (450° C. of the warm working process temperature) and Comparative Examples 4 to 6 (Comparative Example 4: room temperature process, Comparative Example 5: 350° C. of the warm working process temperature, and Comparative Example 6: 600° C. of the warm working process temperature) manufactured pure titanium with 0.37 wt. % of the oxygen concentration and approximately 73% of the cross sectional area reduction ratio at 500° C. of the sequential heat-treatment temperature.

Comparing Example 4 and Comparative Example 4, it can be seen that it is advantageous to obtain an equiaxed microstructure when performing the warm working process and sequential heat-treatment, compared to the cold (room temperature) working process. It is shown in FIGS. 3 and 4 that Example 4 has an overall fine and uniform equiaxed fine grained microstructure, whereas Comparative Example 4 has a non-uniform and uniaxially elongated coarse fine grain microstructure. As a result of quantitative measurement, Example 4 has the equiaxed fine grains formed at 93% or more of an overall fraction ratio and very fine grains with approximately 9.2 μm of an average grain size, while Comparative Example 4 has approximately 72% of an equiaxed grain fraction ratio and coarse grains with approximately 26.4 μm of an average fine grain size. The results of Example 4 and Comparative Example 4 prove that the pure titanium manufacturing method of the present disclosure using the warm working process is more effective in securing a microstructure having fine and equiaxed grains, compared to the conventional pure titanium manufacturing method using the cold working process.

Next, comparing Example 4 and Comparative Examples 5 and 6, it is known that it is advantageous to obtain the fine equiaxed structure in a specific range of processing temperatures even during the warm working process. It is confirmed in FIG. 4 that Example 4 has the overall fine and uniform equiaxed grain microstructure. As a result of quantitative measurement, Example 4 (450° C. of a warm working process temperature) forms the equiaxed fine grains with 93% or more of an overall fraction ratio and very fine grains with 9.2 μm of an average grain size. In contrast, Comparative Example 5 (350° C. of a warm working process temperature) has approximately 81% of an equiaxed fine grain fraction ratio and approximately 22.6 μm of an average grain size, and Comparative Example 6 (600° C. of a warm working process temperature) has 54% of an equiaxed grain fraction ratio and coarse grains with 28.7 μm of an average grain size. Comparative Example 6 (600° C. of a warm working process temperature) has approximately 54% of an equiaxed grain fraction ratio and coarse grains with 28.7 μwoof an average grain size. Similar to the results of Comparative Example 4, the results of Comparative Example 5 show that the cold or warm working process at a too low temperature (less than 400° C.) is not effective in securing the microstructure having the fine and equiaxed grains. In addition, the results of Comparative Example 6 show that when the warm working process temperature is too high, the internal energy accumulated in the material during the warm working process is not effectively accumulated during the processing, further increasing possibility of grain growth, which is not effective in securing the microstructure with the fine and equiaxed grains.

Therefore, the results of Example 4 and Comparative Examples 5 and 6 prove that the specific warm working process temperature condition is more effective in securing the fine and equiaxed grain structure even in the pure titanium manufacturing method using the warm working process.

Effect of Processing Amount:

In Table 1, Example 4 and Comparative Example 7 experimentally prove the effect of the processing amount in the manufacturing method for pure titanium according to the present disclosure.

Example 4 and Comparative Example 7 processed the warm working at 450° C. of a warm working process temperature and sequential heat-treatment at 500° C. of a sequential heat-treatment temperature, for pure titanium with 0.37 wt. % of an oxygen concentration. However, Example 4 processed the warm working process with 70% of a processing amount (a cross sectional reduction ratio) based on the manufacturing method of the present disclosure, while Comparative Example 7 processed the warm working process with 30% of a processing amount.

It is confirmed in FIG. 4 that Example 4 has the overall fine and uniform equiaxed grain microstructure. As a result of quantitative measurement, Example 4 (70% of a warm working process amount) formed the equiaxed grains with 93% or more of a fraction ratio and has very fine grains with 9.2 μm of an average grain size. In contrast, it is confirmed that Comparative Example 7 (30% of a warm working process amount) has 68% of an equiaxed grain fraction ratio and coarse grains with 23.9 μm of an average grain size. The results of Comparative Example 7 means that the equiaxed fraction ratio in the final microstructure is low even after the sequential heat-treatment, even when the process amount is less than 50% even when performing the warm working process at 400 to 550° C. with 0.25 to 0.45 wt. % of an oxygen concentration inside pure titanium. In other words, the results of Example 4 and Comparative Example 7 prove that less than 50% of the warm working process amount of pure titanium is not effective in securing the microstructure with the fine and equiaxed grains.

Effect of Sequential Heat-Treatment:

In Table 1, Example 4 and Comparative Examples 8 and 9 experimentally prove the effect of the sequential heat-treatment temperature in the pure titanium manufacturing method of the present disclosure.

Pure titanium of Example 4 and Comparative Examples 8 and 9 are manufactured under the same conditions except the sequential heat-treatment temperature. Specifically, Example 4 (500° C. of a sequential heat-treatment temperature) and Comparative Examples 8 and 9 (Comparative Example 8: 300° C. of a sequential heat-treatment temperature and Comparative Example 9: 600° C. of a sequential heat-treatment temperature) performed the sequential heat-treatment at different sequential heat-treatment temperatures, respectively after performing the warm working with 0.37 wt. % of an oxygen concentration, approximately 73% of a process amount of a cross sectional reduction ratio, and 450° C. of a warm working process temperature.

Comparing Example 4 and Comparative Example 8, Example 4 has an overall fine and uniform equiaxed grain microstructure, whereas Comparative Example 8 has a non-uniform and uniaxially elongated coarse grain microstructure. As a result of quantitative measurement, Example 4 forms equiaxed grains at 93% or more of a fraction ratio and very fine grains with 9.2 μm of an average grain size. It is confirmed that Comparative Example 8 has only 29% of an equiaxed grain fraction ratio and coarse grains with about 31.5 μm of an average grain size. It is judged that the low equiaxed structure fraction ratio and the large average grain size of Comparative Example 8 are due to insufficient recrystallization during the sequential heat-treatment because the sequential heat-treatment temperature was too low. The results of Example 4 and Comparative Example 8 indicate that the sequential heat-treatment temperature needs to be set to a temperature sufficient to cause recrystallization.

Next, comparing Example 4 and Comparative Example 9, Example 4 has an overall fine and uniform equiaxed grain microstructure, whereas Comparative Example 9 has a uniform but coarse grain microstructure. As a result of quantitative measurement, it is confirmed that Example 4 forms equiaxed grains at 93% or more of a fraction ratio and very fine grains with 9.2 μm of an average grain size. In contrast, it is confirmed that Comparative Example 9 has about 98% of an equiaxed grain fraction ratio but coarse grains with 35.4 μm of an average grain size. It is judged that the high equiaxed structure fraction ratio and large average grain size of Comparative Example 9 are due to the fact that the sequential heat-treatment temperature is too high even when recrystallization occurred sufficiently during the sequential heat treatment but grain growth was promoted due to the high sequential heat-treatment temperature. The results of Example 4 and Comparative Example 9 indicate that the sequential heat-treatment temperature needs to be set to a temperature capable of suppressing the grain growth.

The embodiments are described above with reference to a number of illustrative embodiments thereof. However, the present disclosure is not intended to limit the embodiments and drawings set forth herein, and numerous other modifications and embodiments can be devised by one skilled in the art. Further, the effects and predictable effects based on the configurations in the disclosure are to be included within the range of the disclosure though not explicitly described in the description of the embodiments.

1. Fine grained pure titanium having an equiaxed microstructure fraction ratio of 90% or more and an average grain size of 15 μm or less.

2. The fine grained pure titanium of claim 1, wherein an oxygen concentration in the pure titanium is 0.25 to 0.45 wt. %.

3. The fine grained pure titanium of claim 1, wherein the pure titanium has a plate shape.

4. (canceled)

5. (canceled)

6. (canceled)

7. (canceled)
